(19) United States
(12) Patent Application Publication
(10) Pub. No.: US 2010/0194284 A1
(43) Pub. Date: Aug. 5, 2010

(54) CIRCUIT ARRANGEMENT FOR OPERATING A CONVERTER

(75) Inventor: Bernd Rudolph, Forstern (DE)

Correspondence Address: Viering, Jentschura & Partner - OSR, 3770 Highland Ave., Suite 203, Manhattan Beach, CA, 90266, US

(73) Assignee: OSRAM Gesellschaft mit beschraenkter Haftung, Muenchen (DE)

(21) Appl. No.: 12/697,317

(22) Filed: Feb. 1, 2010

(30) Foreign Application Priority Data
Feb. 3, 2009 (DE) 10 2009 007 159.8

(51) Int. Cl. H05B 41/36

(52) U.S. Cl. 315/119

(57) ABSTRACT

A circuit arrangement for operating a converter, which comprises a bridge circuit having at least a first bridge switch and a second bridge switch and a first bridge center point and a second bridge center point is provided. The circuit arrangement may include a current differential amplifier, the first input of the current differential amplifier being coupled to a first comparison signal input, the second input of the current differential amplifier being coupled to a second comparison signal input, the output of the current differential amplifier being coupled to a control electrode of a first electronic switch.

### CROSS-REFERENCE TO RELATED APPLICATION

This application claims priority to German Patent Application Serial No. 10 2009 007 159.8, which was filed Feb. 3, 2009, and is incorporated herein by reference in its entirety.

### TECHNICAL FIELD

Various embodiments relate to a circuit arrangement for operating a converter.

### BACKGROUND

The defined monitoring of the end of life (EoL) of discharge lamps as a safety-relevant feature has become part of many discharge lamp converters in recent years. In this context, U.S. Pat. No. 6,288,500 has disclosed a discretely implemented circuit, which operates on the basis of the interruption function of integrated control circuits. In the ICB1FL02G module by Infineon, it itself is part of an integrated control circuit for a converter.

The end of life of a discharge lamp is characterized by the fact that the emitter of at least one of the two electrodes has been consumed, with the result that the effective resistance which is represented by the discharge lamp is different in the two directions of flow of the electric current. In a circuit arrangement of the generic type, for the purposes of EoL monitoring a test is performed to establish to what extent the DC component at the second bridge center point of the converter differs from the potential which is provided by the converter at the first bridge center point. If the end of life is not monitored, there is the risk of overheating of the lampholders, which are often made from plastic. The disadvantage of the known solutions consists firstly in that they cannot be implemented inexpensively enough for mass use. There is a further disadvantage for the mentioned IC which consists in it therefore only being possible for converters to be driven by MOS transistors as the switches, but not for converters to be driven by bipolar transistors as the switches.

### SUMMARY OF THE INVENTION

Various embodiments provide a circuit arrangement for operating a converter, which comprises a bridge circuit having at least a first bridge switch and a second bridge switch and a first bridge center point and a second bridge center point. The circuit arrangement may include a supply input for connection to a DC supply voltage; a first comparison signal input, which is coupled to the first bridge center point of the converter; a second comparison signal input, which is coupled to the second bridge center point of the converter; a first output for providing a drive signal for at least one bridge switch of the converter; an interrupting device with a first electronic switch and a second electronic switch, the first electronic switch and the second electronic switch each having a control electrode, a working electrode and a reference electrode, the working electrode of the first electronic switch being coupled to the supply input, the working electrode of the second electronic switch being coupled to the reference potential; the reference electrode of the first electronic switch being coupled to the reference potential, the reference electrode of the second electronic switch being coupled to the supply input, the interrupting device comprising an interrupting output, at which an interrupting signal can be provided; and a first nonreactive resistor and a second nonreactive resistor; the first nonreactive resistor being coupled between the working electrode of the second electronic switch and the reference potential, that terminal of the first nonreactive resistor which is not coupled to the reference potential being coupled to the control electrode of the first electronic switch; the second nonreactive resistor being coupled between the supply input and the working electrode of the first electronic switch, that terminal of the second nonreactive resistor which is not coupled to the supply input being coupled to the control electrode of the second electronic switch; the interrupting output being coupled to a point at which the first nonreactive resistor is coupled to the working electrode of the second electronic switch, the circuit arrangement furthermore including a current differential amplifier, the first input of the current differential amplifier being coupled to the first comparison signal input, the second input of the current differential amplifier being coupled to the second comparison signal input, the output of the current differential amplifier being coupled to the control electrode of the first electronic switch.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of a converter, which can be operated by a circuit arrangement according to an embodiment; and

FIG. 2 shows a schematic illustration of an exemplary embodiment of a circuit arrangement.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a circuit arrangement for operating a converter, which includes a bridge circuit having at least a first bridge switch and a second bridge switch and a first bridge center point and a second bridge center point, the circuit arrangement including: a supply input for connection to a DC supply voltage; a first comparison signal input, which is coupled to the first bridge center point of the converter; a second comparison signal input, which is coupled to the second bridge center point of the converter; a first output for providing a drive signal for at least one bridge switch of the converter; an interrupting device with a first electronic switch and a second electronic switch, the first electronic switch and the second electronic switch each having a control electrode, a working electrode and a reference electrode, the working electrode of the first electronic switch being coupled to the supply input, the working electrode of the second electronic switch being coupled to the reference potential, the reference electrode of the first electronic switch being coupled to the reference potential, the reference electrode of the second electronic switch being coupled to the supply input, the interrupting device including an interrupting output, at which an interrupting signal can be provided; and a first nonreactive resistor and a second nonreactive resistor; the first nonreactive resistor being coupled between the working electrode of the second electronic switch and the reference potential, that terminal of the first nonreactive resistor which is not coupled to the reference potential being coupled to the control electrode of the first electronic switch; the second nonreactive resistor being coupled between the supply input and the working electrode of the first electronic switch, that terminal of the second nonreactive resistor which is not coupled to the supply input being coupled to the control electrode of the second electronic switch; the interrupting output being coupled to a point at which the first nonreactive resistor is coupled to the working electrode of the second electronic switch.

Various embodiments will be presented using the example of a discharge lamp operated by the converter. However, it can also expediently be used in other fields.

Various embodiments develop a circuit arrangement of the generic type in such a way that particularly simple and therefore particularly inexpensive interruption of a converter can be realized in the event of the detection of an EoL state of a discharge lamp.

Various embodiments are based on the knowledge that the abovementioned object can be achieved if the EoL signal is obtained via a current differential amplifier. In this case, the EoL signal only controls the ground-side transistor of the discrete thyristor equivalent circuit, which is implemented by the first and the second electronic switches and by the first and the second nonreactive resistors. As a result, it is possible to trigger this thyristor without a precise potential shift with a positive and a negative EoL signal in order to provide an interrupting signal. Thus, the interruption can be realized in a particularly simple and inexpensive manner in the event of detection of an EoL state.

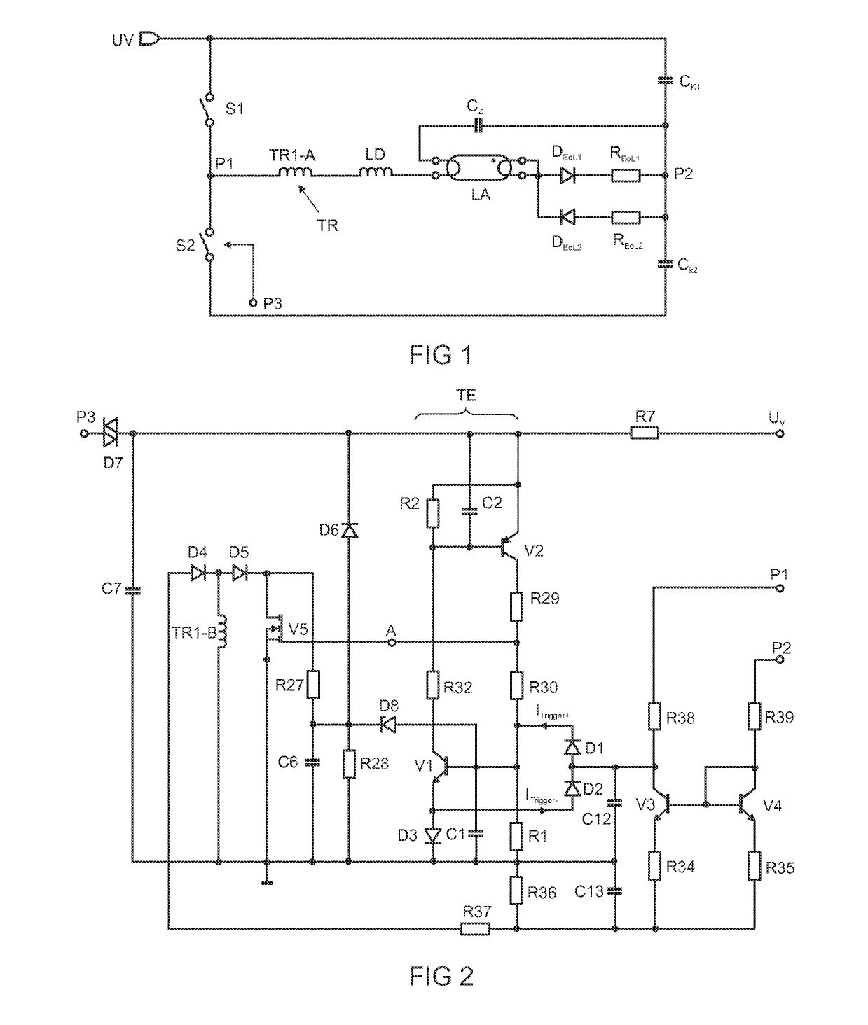

First of all, FIG. 1 shows a schematic illustration of a typical converter, which can be operated by means of a circuit arrangement according to various embodiments. In this case, the points P1, P2, P3, in relation to which more detail is given below, are coupled to the correspondingly denoted points of the exemplary embodiment illustrated in FIG. 2 of a circuit arrangement according to various embodiments.

The converter illustrated in FIG. 1 includes a half-bridge circuit, in which a first bridge switch S1 and a second bridge switch S2 are coupled in series between the terminal Uᵥ for a supply voltage and a reference potential. The series circuit including a first coupling capacitor C_{K1} and a second coupling capacitor C_{K2} is connected in parallel with the half-bridge circuit. The series circuit including a plurality of components is arranged between the first half-bridge center point, which is denoted here by P1, and the second half-bridge center point, which is denoted here by P2. This series circuit includes a winding TR1-A of a transformer TR, a lamp inductor LD, the discharge lamp La, the discharge path being connected in parallel with a striking capacitor C_{Z}, and a parallel circuit including a plurality of elements for EoL detection. This parallel circuit includes a first nonreactive resistor R_{EoL1}, a second nonreactive resistor R_{EoL2}, a first diode D_{EoL1} and a second diode D_{EoL2}, which is connected back-to-back in parallel with said first diode D_{EoL1}. The bridge switch S2 is driven via P3.

Signals from the corresponding terminals in FIG. 1 are supplied via the terminals P1, P2 to the embodiment illustrated in FIG. 2 of a circuit arrangement, while an output signal at the terminal P3 in FIG. 1 is provided at the terminal P3. The circuit arrangement illustrated in FIG. 2 includes a starting circuit, which for its part includes the nonreactive resistor R7, the capacitor C7 and a diac D7. For starting of the circuit arrangement and therefore of the converter, first of all the starting capacitor C7 is charged to a voltage value, for example 32 V, via the nonreactive resistor R7. As soon as the breakdown voltage of the diac D7 has been reached, a signal is provided at the output P3, and this signal results in the converter shown in FIG. 1 starting to oscillate. As soon as the converter oscillates in the steady state, the starting capacitor C7 is discharged to values below the trigger voltage of the diac D7, for example to a voltage value of between 10 and 20 V.

By way of brief summary, for implementing a self-oscillating converter the circuit arrangement illustrated in FIG. 2 serves the purpose of interrupting the converter in the event of detection of an EoL state or a lamp which is unable to strike. An EoL state is present if the DC component of the potential at the input P2 differs from the DC component of the potential at the input P1. In this case, it is necessary for the converter to be interrupted, both when the DC component of the potential at the input P2 is greater than the DC component at the input P1, and when the DC component of the potential at the input P2 is less than the DC component of the potential at the input P1.

For this purpose, the potentials at the points P1 and P2 are supplied to a current differential amplifier, in this case a current mirror. The current mirror includes the transistors V3 and V4. A nonreactive resistor R38 is coupled between the point P1 and the collector of the transistor V3. A nonreactive resistor R39 is coupled between the input P2 and the collector of the switch V4. The collector of the transistor V4 is short-circuited with the base of both the transistor V3 and the transistor V4. Firstly, a nonreactive resistor R34 and, secondly, a nonreactive resistor R35 are coupled between the emitters of the transistors V3, V4 and a negative auxiliary voltage, which will be explained in more detail further below. The signal at the collector of the transistor V3 forms the output of the current mirror. After integration in the capacitor C12, this signal is supplied to a thyristor equivalent circuit TE, which includes the transistors V1 and V2, the transistor V1 being in the form of an npn bipolar transistor, and the transistor V2 being in the form of a pnp bipolar transistor. Other transistors are likewise possible when matched correspondingly to the circuit.

A capacitor C12 is connected between the collector of the transistor V3 and the reference potential. The voltage across the capacitor C12 is firstly coupled via a diode D1 to the base of the transistor V1, and secondly via a diode D2 to the emitter of the transistor V1. The emitter of the transistor V2 is coupled to the input Uᵥ for the supply voltage. The parallel circuit including a nonreactive resistor R2 and a capacitor C2 is coupled between the emitter of the transistor V2 and the base of the transistor V2. A nonreactive resistor R32 is coupled between the base of the transistor V2 and the collector of the transistor V1. A diode D3 is coupled between the emitter of the transistor V1 and the reference potential. The parallel circuit including a capacitor C1 and a nonreactive resistor R1 is coupled between the base of the transistor V1 and the reference potential. The series circuit including two nonreactive resistors R29 and R30 is coupled between the collector of the transistor V2 and the base of the transistor V1. The potential which is present between these two resistors R29, R30 forms the output signal of the thyristor equivalent circuit, in particular the interrupting signal A for the converter. This signal is in this case coupled to the gate of a MOSFET V5. A further winding TR1-B of the transformer TR is coupled firstly to the drain of the MOSFET V5 via a diode D5, and secondly to the parallel circuit comprising a capacitor C6 and a nonreactive resistor R28 via a nonreactive resistor R27. The potential across the parallel circuit including the capacitor C6 and the nonreactive resistor R28 is coupled to the base of the transistor V1 via a zener diode D8.

In order to generate the abovementioned negative auxiliary voltage, the potential across the winding TR1-B is coupled to the electrode of a capacitor C13 via a diode D4 and a nonreactive resistor R37, the electrode not being connected to the reference potential. A nonreactive resistor R36 is coupled in parallel with the capacitor C13. The capacitor C12 can thus be charged to negative voltages, as a result of which in turn the emitter of the transistor V1 can assume negative values in comparison with the reference potential. In order to decouple the emitter of the transistor V1 from the reference potential, the diode D3 is therefore required. The base of the transistor V1 is coupled to the reference potential via the nonreactive resistor R1.

Operation: In general it can be maintained that as soon as the transistor V1 is switched on, i.e. by virtue of a corresponding potential difference being set between its base and its emitter, a base current for the transistor V2 is generated. If the transistor is switched on, for its part it generates a base current for the transistor V1, with the result that a holding function can be implemented. In this case, this holding current may be set to values of the order of magnitude of approximately 100 μA via the nonreactive resistors R1, R2.

The capacitor C12 serves to integrate the difference between the collector currents of the transistors V3, V4. This difference represents a measure for the EoL power at the discharge lamp La. Depending on the polarity of the EoL signal at C12, either a positive current therefore flows via the diode D1 into the base of the transistor V1 if the forward voltage of the transistor V1 and the diode D3 is overcome, or a negative current flows via the diode D2 into the emitter of the transistor V1. As a result, given a corresponding amplitude the interrupting thyristor TE is triggered. The positive trigger current is determined by

$${I}_{Trigger +} \approx \frac{{U}_{BEFV 1} + {U}_{FD 3}}{R 1} ,$$

where I_{Trigger+} denotes the current through the diode D1, U_{BEFV1} denotes the base-emitter forward voltage of the transistor V1, and U_{FD3} denotes the forward voltage of the diode D3.

The negative trigger current I_{Trigger-}, which flows through the diode D2, is determined by

$${I}_{Trigger -} \approx \frac{{U}_{BEFV 2}}{R 2} ,$$

where U_{BEFV2} represents the base-emitter forward voltage of the transistor V2.

The positive trigger current I_{Trigger+} and the negative trigger current I_{Trigger-} can thus be set to identical rated values and the thyristor simulation TE can be triggered given the same absolute value for the EoL power.

Since first of all the transistor V1 is driven with the present configuration in all interruption cases, the circuit does not require a potential shift in order to drive, for example, the transistor V2. Otherwise, its emitter potential would also have to be fixed in all operating states, or else this trigger path would have to be switched, which would represent increased complexity.

With the present circuit arrangement, not only is an EoL state detected, but also open-circuit operation of the converter, i.e. a broken filament or a removed lamp. For this purpose, the current in the converter is detected via the winding TR1-B. Using the diode D5, rectification and charging of the capacitor C6 take place via the nonreactive resistors R27, R28. When the lamp is deactivated, an excessively high current or an excessively high voltage is detected via the winding TR1-B. The combination of the components C6, R27, R28 represents a timing element, which is generally dimensioned with respect to a time constant of from 10 to 100 ms. If the lamp La has not been struck within this period of time, the voltage across the capacitor C6 exceeds the breakdown voltage of the zener diode D8, as a result of which a base current for the transistor V1 begins to flow.

Part of the current through the zener diode D8 also flows via the nonreactive resistor R1 to the reference potential, however.

If the voltage across the nonreactive resistor R1 exceeds the sum of the voltages U_{BEFV1} and U_{FD3}, the transistor V1 is switched on, as a result of which a base current for the transistor V2 is generated. The thyristor equivalent circuit TE thus transfers to its holding state.

As a result of the interrupting signal at the output of the thyristor equivalent circuit, the winding TR1-B is short-circuited, as a result of which the excitation of the transformer TR is interrupted such that, as a result, the windings (not illustrated), which are coupled to the winding TR1-B, in the drive circuits for the switches S1, S2 are switched off.

Normally, the thyristor equivalent circuit TE is coupled to the input Uᵥ for the supply voltage via the nonreactive resistor R7. However, a filament of the discharge lamp LA is often connected in series with the resistor R7 in order to make it possible thereby to detect a lamp which has been inserted into the lampholder. Thus, in the event of a broken filament, the interruption function would then cease as a result of the lack of supply to the thyristor equivalent circuit TE. For this purpose, the charge present across the capacitor C6 is in this case used, via the diode D6, to supply the thyristor equivalent circuit TE. In this case, the components should be dimensioned such that they provide sufficient energy until the converter has reached a decayed state after a filament breakage.

In each case one capacitor C1, C2 is connected in parallel with the nonreactive resistors R1, R2 in order to avoid triggering of the thyristor equivalent circuit TE as a result of faults. Direct driving of the transistor V2 is impossible, as has already been mentioned, since the emitter of the transistor V2 is not at a fixed potential in all operating states: for example, the potential at the emitter of the transistor V2 at the beginning is charged to the breakdown voltage, for example 32 V, of the diac D7, then the voltage is lowered to a lower value, for example from 10 to 20 V, in order to prevent disruptive striking of the diac D7 during continuous operation of the circuit arrangement. In the case of the present circuit arrangement, the potential across the emitter of the transistor V2 is insignificant for the triggering of the thyristor equivalent circuit TE since, once an EoL state has been detected, the transistor V1 is always driven.

While the exemplary embodiment illustrated in FIG. 2 relates to the driving of a self-oscillating converter, various embodiments can also be used in an externally controlled converter. In this case, the interrupting signal can be used to interrupt the drive apparatus for the switches S1, S2 of the half-bridge.

In various embodiments, the current differential amplifier includes a third electronic switch and a fourth electronic switch, each having a control electrode, a working electrode and a reference electrode, the working electrode of the third electronic switch being coupled to the first comparison signal input or the second comparison signal input and the working electrode of the fourth electronic switch being coupled to the second comparison signal input or the first comparison signal input, the working electrode of the fourth electronic switch being coupled to the control electrode of the third electronic switch and of the fourth electronic switch, the output of the current differential amplifier being coupled to the working electrode of the third electronic switch. This measure makes it possible to condition the signals applied to the comparison signal inputs by means of a single current differential amplifier.

In various embodiments, a first capacitor is furthermore provided and coupled between the output of the current differential amplifier and the reference potential. As a result, the signal at the output of the current differential amplifier is integrated and smoothed.

In various embodiments, in this case a first diode is furthermore provided and coupled between the output of the current differential amplifier and the control electrode of the first electronic switch, and a second diode is coupled between the output of the current differential amplifier and the reference electrode of the first electronic switch. Thus, the thyristor simulation can be triggered from the current differential amplifier without a potential shift exclusively via the first electronic switch both with a positive and a negative output current.

In various embodiments, the circuit arrangement may furthermore include an auxiliary voltage source, which is configured to provide an auxiliary voltage at its output, the auxiliary voltage having the opposite mathematical sign from the DC supply voltage to be connected at the supply input, the output of the auxiliary voltage source being coupled to the reference electrodes of the third electronic switch and the fourth electronic switch. This makes it possible in a particularly simple and inexpensive manner to evaluate the case in which the potential at the second comparison signal input is greater than the potential provided by the first comparison signal input.

In various embodiments, in particular in this context, a third diode is also provided, which is coupled between the reference electrode of the first electronic switch and the reference potential. As a result, the reference electrode of the first electronic switch can actually be triggered by a negative current in the first place.

In various embodiments, the circuit arrangement may furthermore include a second winding, which is coupled to a first winding in the output circuit of the converter, and a fifth electronic switch having a control electrode, a reference electrode and a working electrode, the control electrode of the fifth electronic switch being coupled to the interrupting output, the fifth electronic switch being coupled to the second winding in such a way that it short-circuits the second winding in the event of the occurrence of an interrupting signal at the interrupting output. Owing to this simple measure, interruption of the converter in the event of the occurrence of an interrupting signal, i.e. after detection of an EoL state, is reliably brought about.

In various embodiments, the auxiliary voltage source may include the second winding, the second winding having a first and a second terminal, the first terminal of the second winding being coupled to the reference potential, the auxiliary voltage source furthermore including a fourth diode and a fifth diode, the fourth diode being coupled between the second terminal of the second winding and the output of the auxiliary voltage source, the fifth diode being coupled between the second terminal of the second winding and the working electrode of the fifth electronic switch. In this way, the second winding can be used to generate the required auxiliary voltage during the times in which no EoL state is detected. This dual function of the second winding results in a particularly inexpensive implementation of this embodiment of a circuit arrangement according to various embodiments.

In various embodiments, in this case, it may be particularly advantageous if a third capacitor is coupled between the working electrode of the fifth electronic switch and the reference potential. This ensures that when a lamp is deactivated, during which time striking is naturally impossible, the interrupting device is activated. If the third capacitor has a first and a second terminal, the first terminal of the third capacitor being coupled to the reference potential, then the second terminal of the capacitor is in this case coupled to the control electrode of the first electronic switch via a zener diode. Furthermore, the third capacitor enables the implementation of an additional supply to the interrupting device in the case of an interrupted power supply from the supply voltage. This operates until the converter has decayed. If the third capacitor now again has a first and a second terminal, the first terminal of the third capacitor being coupled to the reference potential, then for this additional supply the second terminal of the capacitor is coupled to the supply input via a sixth diode.

In various embodiments, the circuit arrangement may furthermore include a third nonreactive resistor, a fourth capacitor and a breakdown element, the third nonreactive resistor being coupled in series with the supply input, the third capacitor being coupled between that terminal of the third nonreactive resistor which is not coupled to the supply input and the reference potential, and the breakdown element being coupled to the node between the third nonreactive resistor and the fourth capacitor and to the first output of the circuit arrangement. This results in a starting circuit known per se, in which the fourth capacitor is charged from the supply voltage connected to the supply input via the third nonreactive resistor until the breakdown voltage of the breakdown element has been reached. As a result, a starting pulse for the converter is generated. In various embodiments, the fourth capacitor is then actively discharged, with the result that the voltage present across the capacitor is below the voltage of the breakdown element and, during continuous operation of the converter, no undesirable starting pulses occur.

In order to implement a self-oscillating oscillator, further windings may be coupled to the first winding in the output circuit of the converter, the further windings serving to drive the bridge switches of the converter. Various embodiments can also be used in externally controlled converters, however. For this purpose, a circuit arrangement according to various embodiments may furthermore include a drive apparatus, whose output is coupled to the first output of the circuit arrangement, the interrupting output being coupled to an input of the drive apparatus in such a way that the provision of a signal at the output of the drive apparatus ceases when an interrupting signal is present at the interrupting output. If, accordingly, an EoL state is detected, the drive apparatus is driven in such a way that it no longer provides a signal for driving the bridge switches. The converter is thus switched to the deactivated state.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A circuit arrangement for operating a converter, which comprises a bridge circuit having at least a first bridge switch and a second bridge switch and a first bridge center point and a second bridge center point, the circuit arrangement comprising:
a supply input for connection to a DC supply voltage;
a first comparison signal input, which is coupled to the first bridge center point of the converter;
a second comparison signal input, which is coupled to the second bridge center point of the converter;
a first output for providing a drive signal for at least one bridge switch of the converter;
an interrupting device with a first electronic switch and a second electronic switch, the first electronic switch and the second electronic switch each having a control electrode, a working electrode and a reference electrode, the working electrode of the first electronic switch being coupled to the supply input, the working electrode of the second electronic switch being coupled to the reference potential;
the reference electrode of the first electronic switch being coupled to the reference potential, the reference electrode of the second electronic switch being coupled to the supply input,
the interrupting device comprising an interrupting output, at which an interrupting signal can be provided; and
a first nonreactive resistor and a second nonreactive resistor;
the first nonreactive resistor being coupled between the working electrode of the second electronic switch and the reference potential, that terminal of the first nonreactive resistor which is not coupled to the reference potential being coupled to the control electrode of the first electronic switch;
the second nonreactive resistor being coupled between the supply input and the working electrode of the first electronic switch, that terminal of the second nonreactive resistor which is not coupled to the supply input being coupled to the control electrode of the second electronic switch;
the interrupting output being coupled to a point at which the first nonreactive resistor is coupled to the working electrode of the second electronic switch,
the circuit arrangement furthermore comprising a current differential amplifier, the first input of the current differential amplifier being coupled to the first comparison signal input, the second input of the current differential amplifier being coupled to the second comparison signal input, the output of the current differential amplifier being coupled to the control electrode of the first electronic switch.

2. The circuit arrangement as claimed in claim 1,
wherein the current differential amplifier comprises a third electronic switch and a fourth electronic switch, each having a control electrode, a working electrode and a reference electrode, the working electrode of the third electronic switch being coupled to the first comparison signal input or the second comparison signal input and the working electrode of the fourth electronic switch being coupled to the second comparison signal input or the first comparison signal input, the working electrode of the fourth electronic switch being coupled to the control electrode of the third electronic switch and of the fourth electronic switch, the output of the current differential amplifier being coupled to the working electrode of the third electronic switch.

3. The circuit arrangement as claimed in claim 1, further comprising:
a first capacitor coupled between the output of the current differential amplifier and the reference potential.

4. The circuit arrangement as claimed in claim 1, further comprising:
a first diode coupled between the output of the current differential amplifier and the control electrode of the first electronic switch.

5. The circuit arrangement as claimed in claim 2, further comprising:
an auxiliary voltage source, which is configured to provide an auxiliary voltage at its output, the auxiliary voltage having the opposite mathematical sign from the DC supply voltage to be connected at the supply input, the output of the auxiliary voltage source being coupled to the reference electrodes of the third electronic switch and the fourth electronic switch.

6. The circuit arrangement as claimed in claim 5, further comprising:
a second diode, which is coupled between the output of the current differential amplifier and the reference electrode of the first electronic switch.

7. The circuit arrangement as claimed in claim 1, further comprising:
a third diode, which is coupled between the reference electrode of the first electronic switch and the reference potential.

8. The circuit arrangement as claimed in claim 1, further comprising:
a second winding, which is coupled to a first winding in the output circuit of the converter, and a fifth electronic switch having a control electrode, a reference electrode and a working electrode, the control electrode of the fifth electronic switch being coupled to the interrupting output, the fifth electronic switch being coupled to the second winding in such a way that it short-circuits the second winding in the event of the occurrence of an interrupting signal at the interrupting output.

9. The circuit arrangement as claimed in claim 8,
wherein the auxiliary voltage source comprises the second winding, the second winding having a first and a second terminal, the first terminal of the second winding being coupled to the reference potential, the auxiliary voltage source furthermore comprising a fourth diode and a fifth diode, the fourth diode being coupled between the second terminal of the second winding and the output of the auxiliary voltage source, the fifth diode being coupled between the second terminal of the second winding and the working electrode of the fifth electronic switch.

10. The circuit arrangement as claimed in claim 8, further comprising:
a third capacitor coupled between the working electrode of the fifth electronic switch and the reference potential.

11. The circuit arrangement as claimed in claim 10,
wherein the third capacitor has a first and a second terminal, the first terminal of the third capacitor being coupled to the reference potential, the second terminal of the capacitor being coupled to the supply input via a sixth diode.

12. The circuit arrangement as claimed in claim 11,
wherein the third capacitor has a first and a second terminal, the first terminal of the third capacitor being coupled to the reference potential, the second terminal of the capacitor being coupled to the control electrode of the first electronic switch via a zener diode.

13. The circuit arrangement as claimed in claim 8, further comprising:
a third nonreactive resistor, a fourth capacitor and a breakdown element, the third nonreactive resistor being coupled in series with the supply input, the third capacitor being coupled between that terminal of the third nonreactive resistor which is not coupled to the supply input and the reference potential, and the breakdown element being coupled to the node between the third nonreactive resistor and the fourth capacitor and to the first output of the circuit arrangement.

14. The circuit arrangement as claimed in claim 1, further comprising:
a drive apparatus, whose output is coupled to the first output of the circuit arrangement, the interrupting output being coupled to an input of the drive apparatus in such a way that the provision of a signal at the output of the drive apparatus ceases when an interrupting signal is present at the interrupting output.
